(19) United States
(12) Patent Application Publication
(10) Pub. No.: US 2026/0203635 A1
(43) Pub. Date: Jul. 16, 2026

(54) DEVICE AND METHOD FOR QUANTUM PROBABILISTIC MODEL CHECKING FOR TIME-BOUNDED PROPERTIES

(71) Applicant: Korea University Research and Business Foundation, Seoul (KR)

(72) Inventors: Hakjoo OH, Seoul (KR); Chan Gu KANG, Seoul (KR)

(21) Appl. No.: 19/444,499

(22) Filed: Jan. 9, 2026

(30) Foreign Application Priority Data
Jan. 10, 2025 (KR) 10-2025-0004120
May 23, 2025 (KR) 10-2025-0067183

(51) Int. Cl. G06N 10/60; G06N 10/20

(52) U.S. Cl. CPC G06N 10/60; G06N 10/20

(57) ABSTRACT

The present disclosure provides an apparatus and method for probabilistic model checking for time-bounded properties using quantum computing. In the present disclosure, a computing device for quantum probabilistic model checking is configured to convert a probabilistic model checking setting into a quantum circuit that acts on an initial state for multiple qubits and a single qubit of quantum amplitude estimation, and to estimate a probability that a time-bounded property is satisfied by utilizing the quantum amplitude.

### CROSS-REFERENCE TO RELATED APPLICATION(S)

This application claims the priority benefit of Korean Patent Application No. 10-2025-0004120, filed on Jan. 10, 2025 and Korean Patent Application No. 10-2025-0067183, filed on May 23, 2025, in the Korean Intellectual Property Office, the disclosures of which are incorporated herein by reference.

### BACKGROUND

### Field of the Invention

This disclosure relates to a device and method for probabilistic model checking for time-bounded properties using quantum computing.

### Description of the Related Art

Systems composed of multiple interacting components (e.g., distributed systems) often exhibit probabilistic behavior to maintain stability even amidst uncertainty inherent in complex interactions. For example, Herman's randomized self-stabilizing protocol is designed to allow a distributed system to recover to a stable state from an arbitrary initial state, even if some components temporarily fail due to various factors such as network failures, hardware faults, or temporary software issues.

To automatically analyze the safety and performance of such probabilistic systems, Probabilistic Model Checking (PMC) techniques have been utilized. Probabilistic model checking models a system as a Discrete-Time Markov Chain (DTMC) and analyzes it to provide answers to various property questions, including time-bounded properties such as “the probability of reaching a stable state within 10 steps from a specific initial state.” Probabilistic model checking is actively used to analyze various probabilistic systems in the real world.

### SUMMARY

The purpose of this disclosure is to analyze large-scale probabilistic systems with high accuracy. Existing methods using classical computers do not overcome the trade-off between scalability and accuracy. Therefore, this disclosure provides a device and method for probabilistic model checking for time-bounded properties using quantum computing.

The present disclosure aims to analyze large-scale probabilistic systems with high accuracy. Existing methods using classical computers fail to overcome the trade-off between scalability and accuracy. Therefore, the present disclosure provides a device and method for probabilistic model checking for time-bounded properties using quantum computing.

According to the present disclosure, a method of operation for a computing device for Quantum Probabilistic Model Checking (QPMC) may include: a step of converting a Probabilistic Model Checking (PMC) setting into a quantum circuit that acts on an initial state for multiple qubits and a single qubit of Quantum Amplitude Estimation (QAE); and a step of estimating the probability that a time-bounded property is satisfied by utilizing the Quantum Amplitude Estimation.

According to the present disclosure, a computing device for quantum probabilistic model checking includes a memory and a processor connected to the memory and configured to execute at least one instruction stored in the memory. The processor may be configured to convert a probabilistic model checking setting into a quantum circuit that acts on an initial state for multiple qubits and a single qubit of quantum amplitude estimation, and to estimate the probability that a time-bounded property is satisfied by utilizing the quantum amplitude estimation.

According to the present disclosure, QPMC achieves a square-root level lower time complexity than SMC for the same error bound and confidence level. Additionally, QPMC's qubit optimization technique leads to an average 37% reduction in qubit requirements in benchmarks. Unlike such classical approaches, QPMC provides a quantum solution for PMC that addresses the limitations of both non-statistical and statistical methods. Compared to non-statistical methods, QPMC efficiently handles large-scale systems by superposing states within a logarithmic scale of qubits. Compared to statistical methods, QPMC systematically converts models into quantum circuits, providing superior asymptotic complexity than SMC even without prior model knowledge.

### BRIEF DESCRIPTION OF THE DRAWINGS

FIG. 1 is a diagram illustrating Probabilistic Model Checking (PMC) by way of example.

FIG. 2 is a diagram illustrating the PMC language.

FIG. 3 is a diagram illustrating a quantum circuit representing a quantum algorithm.

FIG. 4 is a diagram illustrating the language of quantum circuits.

FIG. 5 is a diagram illustrating the overall Quantum Amplitude Estimation (QAE) circuit.

FIG. 6 shows a Quantum Probabilistic Model Checking (QPMC) process for the example presented in FIG. 1.

FIG. 7 is a diagram showing a preprocessed system module for the model of FIG. 1.

FIG. 8A is a diagram illustrating the execution of the preprocessed system module of FIG. 7.

FIG. 8B is a diagram illustrating the execution of the preprocessed system module of FIG. 7.

FIG. 8C is a diagram illustrating the execution of the preprocessed system module of FIG. 7.

FIG. 9 is a diagram illustrating model translation for the preprocessed system module of FIG. 7.

FIG. 10A is a diagram illustrating a quantum circuit for the preprocessed system module of FIG. 7.

FIG. 10B is a diagram illustrating a quantum circuit for the preprocessed system module of FIG. 7.

FIG. 11 is a diagram additionally illustrating FIG. 10A.

FIG. 12 is a diagram additionally illustrating FIG. 10B.

FIG. 13 is a diagram illustrating the recycling of state qubits according to the present disclosure.

FIG. 14 is a diagram illustrating a batch recycling strategy according to the present disclosure.

FIGS. 15A and 15B show the rate of change in the number of qubits and gates after optimization according to the present disclosure.

FIG. 16 is a diagram schematically illustrating a computing device for Quantum Probabilistic Model Checking according to the present disclosure.

FIG. 17 is a diagram schematically illustrating an operating method of a computing device for Quantum Probabilistic Model Checking according to the present disclosure.

### DETAILED DESCRIPTION

Hereinafter, various embodiments of the present disclosure will be described with reference to the accompanying drawings.

### Probabilistic Model Checking

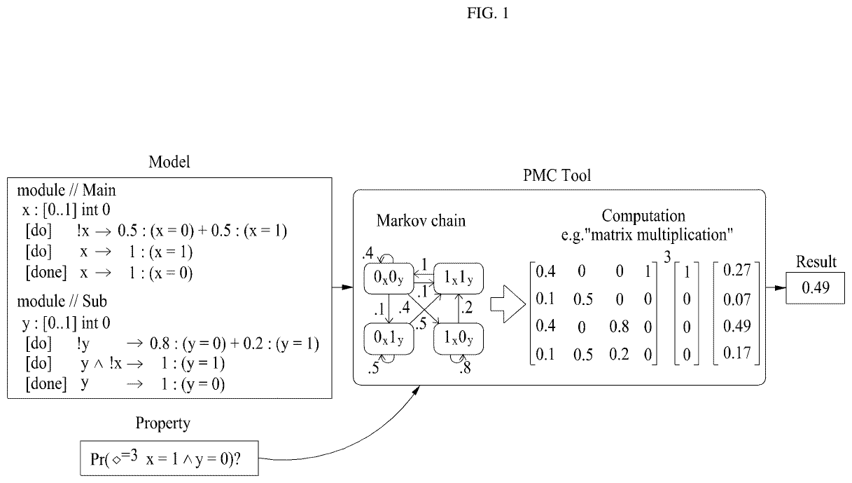

FIG. 1 is a diagram illustrating Probabilistic Model Checking (PMC) by way of example.

Probabilistic Model Checking is a verification technique designed to automate the analysis of probabilistic systems. It extends traditional model checking to quantify probabilistic properties such as “the probability that an unsafe event occurs.” Probabilistic model checking provides a robust framework for evaluating safety, performance, and fault tolerance in various domains, from computer networks to biological processes.

Various probabilistic model checking tools generally follow a common workflow consisting of the following three steps:
1. Model Description: Users first describe probabilistic systems using model description languages such as PRISM and JANI. FIG. 1 shows a model composed of two modules, where Main waits until Sub completes its task. Each module has state variables x and y, representing ready (0) or task complete (1), respectively. This model describes state transition rules through commands. For example, Main's first command [do]!x→0.5: (x=0)+0.5: (x=1) means that when this command is activated, x is updated to 0 or 1 with a 50% probability. The command's guard condition (!x) is satisfied and the synchronized action (do) is activated. An action is activated when each module includes a command for that action that satisfies its guard condition. For example, in state {x [symbol] 1, y [symbol] 0}, Main's second command and Sub's first command are activated together with the do action, and thus x remains 1 and y transitions to 1 with a 20% probability.
2. Property Specification: Users specify properties to be analyzed using temporal logic formulas such as Probabilistic Computation Tree Logic (PCTL). FIG. 1 includes a time-bounded query for the probability that Main has completed its task and Sub is in a ready state after three transitions.
3. Computation: Probabilistic model checking tools compute the probability of a specified property for the described model. FIG. 1 shows a Markov chain of the model with four states and corresponding transition probability matrix, illustrating state-to-state transition probabilities. The result is obtained by multiplying this matrix three times by a vector for the initial state {x [symbol] 0, y [symbol] 0}, indicating a 49% probability of reaching the target state {x [symbol] 1, y [symbol] 0} after three transitions.

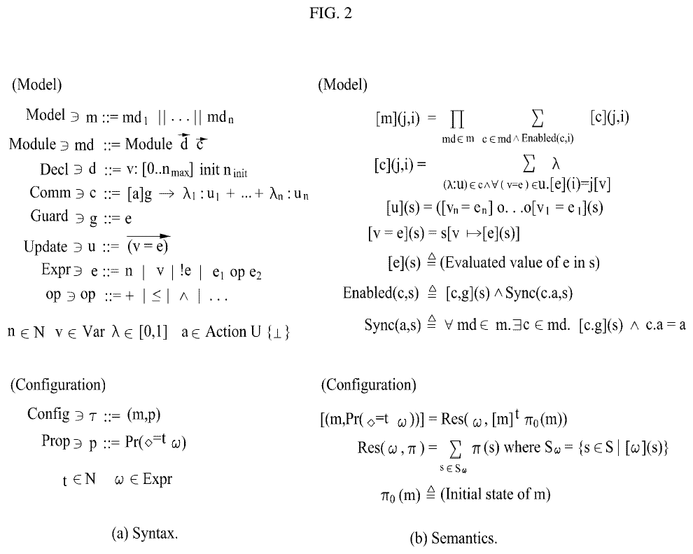

FIG. 2 is a diagram illustrating the PMC language.

Syntax: We use a simplified core language of PMC from PRISM. FIG. 2(a) shows the syntax. A DTMC model consists of individual modules with different variable declarations and commands. Variables have an initial value nᵢₙᵢₜ and a maximum value nₘₐₓ, and are thus limited to integer values from 0 to nₘₐₓ. Each command consists of (1) an action name ‘a’ for synchronization, (2) a guard condition ‘g’ that determines the conditions under which the command can be invoked, and (3) probabilistic updates. Each probabilistic update is denoted as λᵢ: uᵢ for a given index i, and includes the probability λᵢ that the update is chosen and the update operation uᵢ in the form of an assignment v=e between a variable v and an expression e. The expression e is defined in a standard way. As a syntactic implication, we can use formulas as temporary variables in expressions.

A PMC problem configuration t consists of a model m and a property p. The property p consists of a number of transitions t and a Boolean expression o defining the target state set. For example, the property Pr(♦=3 x=1 ∧y=0) in FIG. 1 represents a time-bounded query for the probability of reaching state {x [symbol] 1, y [symbol] 0} after 3 transitions. While original PMC can handle various properties of PCTL, the present disclosure focuses on time-bounded reachability properties.

Semantics: FIG. 2(b) shows the semantics as state-to-state transition probabilities. A state s∈S=Var→N is a variable map, and the semantics of model m is a function: S×S→[0, 1]. Here, [[m]](j, i) denotes the probability of transitioning from state i to j. For simplicity, [[m]] can be represented as a matrix, and state s as a number representing the global state of the model (e.g., s=10₂ for state {x [symbol] 1, y [symbol] 0}). The transition probability [[m]](j, i) is defined as the product of local transition probabilities across all activated commands in all modules. A command c is activated when its guard condition e.g is met and its corresponding action c.a is enabled (Enabled(c,i)). An action ‘a’ is enabled when each module contains at least one command for that action whose guard condition is met (Sync (a, i)).

The semantics [[τ]]∈[0,1] of a PMC configuration τ=(m, Pr(♦=tω)) is the probability that ω is satisfied after t transitions in m. The initial state π_0(m):S→[0,1] of the model represents the initial state of model m, determined by the initial values of its variables, as a one-hot vector. And S_{ω}⊆S denotes the set of target states satisfying the Boolean expression o. For example, the semantics of the PMC configuration t=(m, Pr(♦=3 x=1 ∧y=0)) presented in FIG. 1 is defined as in [Equation 1] below (where S_{ω}={10₂}).

$$\begin{matrix}[ Equation 1 ] & \\ τ 〛 = {\sum }_{s ∈ {S}_{ω}} {〚 m 〛}^{3} {π}_{0} ( m ) = {\sum }_{s ∈ {S}_{ω}} ( {[ \begin{matrix}0.4 & 0 & 0 & 1 \\ 0.1 & 0.5 & 0 & 0 \\ 0.4 & 0 & 0.8 & 0 \\ 0.1 & 0.5 & 0.2 & 0\end{matrix} ]}^{3} [ \begin{matrix}1 \\ 0 \\ 0 \\ 0\end{matrix} ] ) \approx {\sum }_{s ∈ \{ 1 {0}_{2} \}} [ \begin{matrix}0.27 \\ 0.07 \\ 0.49 \\ 0.17\end{matrix} ] = 0.4 9 . & \end{matrix}$$

### Quantum Computing

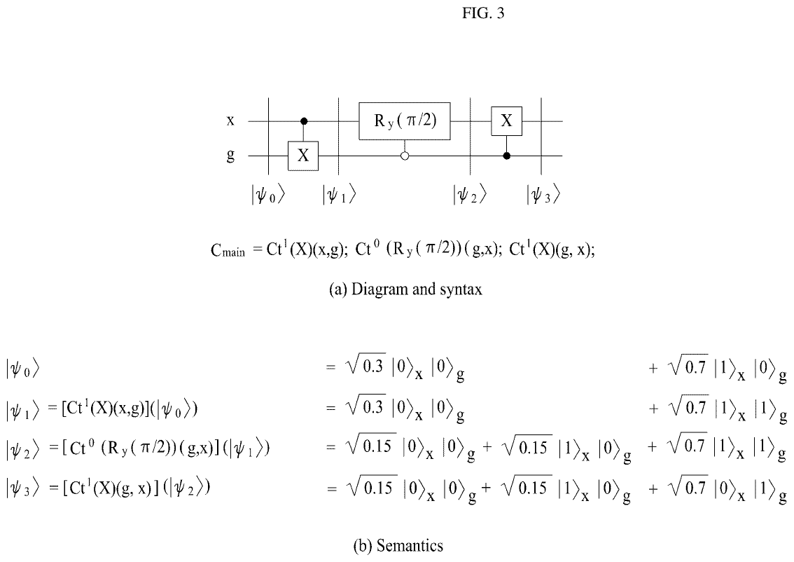

FIG. 3 is a diagram illustrating a quantum circuit representing a quantum algorithm.

Quantum computing accelerates computationally intensive tasks by leveraging quantum mechanical phenomena. FIG. 3(a) shows a circuit diagram and its syntax. In the circuit, each line represents a qubit (quantum bit), the basic unit of information. Unlike classical bits, qubits can exist in a superposition of two basic states, meaning they probabilistically exist in both states, enabling parallel computation of probabilities. The blocks in the circuit are quantum gates that manipulate qubit states.

Qubits: The state of n qubits is represented by a unit vector in [symbol] . This state can be represented as a superposition (linear combination) of computational (standard) basis vectors in [symbol] . For example, a 1-qubit state is expressed as a₀|0 [symbol] +a₁|1 [symbol] , where a₀, a₁ ∈ [symbol] satisfy |a₀|²+|a₁|²=1. |0 [symbol] and |1 [symbol] are computational basis vectors [1 0]† and [0 1]†, respectively, where † denotes the conjugate transpose. Generally, an n-qubit state |ψ [symbol] can be represented as

$$\vert ψ 〉 = {\sum }_{i = 0}^{{2}^{n} - 1} {a}_{i} \vert i 〉 .$$

Here, each |i [symbol] is a one-hot vector of 2ⁿ dimensions with the i-th element being 1, and all coefficients satisfy

$${\sum }_{i = 0}^{{2}^{n} - 1} {\vert {a}_{i} \vert}^{2} = 1 .$$

Basis vectors are expressed as tensor products of basis vectors of smaller qubit systems; for example, in |10₂ [symbol] =|1₂ [symbol] ⊗|0₂ [symbol] , |10₂ [symbol] is a basis vector of a 2-qubit system, and |1₂ [symbol] and |0₂ [symbol] are basis vectors in a 1-qubit system. For convenience, when clear from context, the subscript “2” indicating a binary number and the tensor product symbol ⊗ are omitted.

Each quantum state has a probability distribution over possible measurement outcomes. Measuring the state

$${\sum }_{i = 0}^{{2}^{n} - 1} {a}_{i} \vert i >$$

collapses it to an arbitrary |i [symbol] basis state, with a probability of |aᵢ|². For example, in FIG. 3(b), the final state |ψ₃ [symbol] of qubits x and g is expressed as √0.15|0 [symbol] ₓ|0 [symbol] _{g}+√0.15|1 [symbol] ₓ|0 [symbol] _{g}+√0.7|0 [symbol] ₓ|1 [symbol] _{g}, which indicates that the |00 [symbol] state has a 15% probability, the |10 [symbol] state has a 15% probability, and the |01 [symbol] state has a 70% probability of being measured. Here, the subscripts “x” or “g” denote the names of the qubits. The probability distribution of a partial measurement is the marginal probability distribution over the possible outcomes. For example, if only qubit x is measured from state |ψ₃), the |0 [symbol] ₓ state appears with 85% probability, and the |1 [symbol] ₓ state with 15% probability. Pm(|ψ [symbol] , q^{→}) denotes the partial measurement probability distribution of qubit q^{→} in state |ψ [symbol] , and is expressed as, for example, Pm(|ψ₃ [symbol] , x)=[0.85, 0.15].

Gates: Gates represent unitary transformations of qubit states. Formally, an n-qubit gate G is a 2ⁿ×2ⁿ unitary matrix [[G]] that maps a state |ψ [symbol] ∈C⁽²^{ⁿ}⁾ to a new state [[G]]|ψ [symbol] . For convenience, the notation [[G]] is also used for the mapping itself. In circuit diagrams, gates are represented as blocks above the lines. For example, [symbol] denotes an X gate.

The present disclosure uses well-known gates from various literature, and the meaning of each gate is as shown in [Equation 2] below.

$$\begin{matrix}[ Equation 2 ] & \\ \begin{matrix}〚 I 〛 := [ \begin{matrix}1 & 0 \\ 0 & 1\end{matrix} ] & 〚 X 〛 := [ \begin{matrix}0 & 1 \\ 1 & 0\end{matrix} ] & 〚 {R}_{y} ( θ ) 〛 := [ \begin{matrix}cos ( θ / 2 ) & - sin ( θ / 2 ) \\ sin ( θ / 2 ) & cos ( θ / 2 )\end{matrix} ]\end{matrix} & \end{matrix}$$

The I gate is a 1-qubit identity gate that leaves the state unchanged. The X gate maps state |i [symbol] to |i′ [symbol] , where i′ is the bit complement of i. The R_{y}(θ) “y-rotation” gate maps |i [symbol] to cos(θ/2)|i [symbol] +(−1)ⁱ sin(θ/2)|i′ [symbol] , where θ is the rotation angle. This gate is used to express arbitrary probability distributions. It is important to note that the meaning of a gate, expressed as a unitary matrix, fully describes its mapping from these basis vectors.

Ct_{\vec{b}}(G) “controlled-G” gate applies G to the target qubits when the control qubits are in state \vec{b}.

Formally,

$$⌈ ⌈ {Ct}_{\vec{b}} ( G ) ⌉ ⌉ := \vert {i}_{1} > \vert {i}_{2} > ↦ \vert {i}_{1} > {⌈ ⌈ G ⌉ ⌉}^{\{ {i}_{1} = \vec{b} \}} \vert {i}_{2} > ,$$

where |i₁>∈{|0>, |1>}⁽ⁿ^{₁}⁾ and |i₂>∈{|0>, |1>}⁽ⁿ^{₂}⁾ are the basis vectors for the control and target qubits, respectively. \vec{b}∈0,1⁽ⁿ^{₁}⁾ denotes the control condition for n₁ qubits, and G is an n₂-qubit gate. A 1-bit controlled gate is represented by an empty circle (◯) when 6=0, and by a filled circle (●) when b=1, visualized as a block indicating the control qubit.

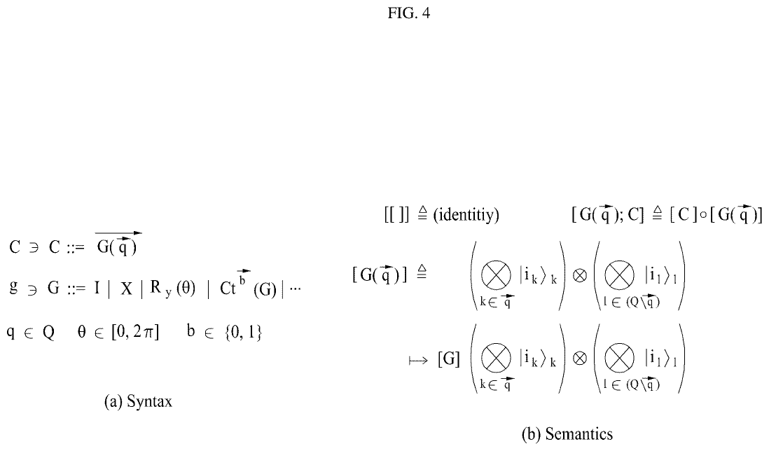

FIG. 4 is a diagram illustrating the language of quantum circuits.

Circuits: FIG. 4 shows the syntax and semantics of quantum circuits. A circuit C consists of a sequential application of gates G(q\vec{ }), where G is a gate, q\vec{ } is a sequence of qubits, and Q is the finite set of qubits under consideration. For example, Cₘₐᵢₙ in FIG. 3(a) represents a circuit composed of 4 gates. Furthermore, the circuit must satisfy the well-formed conditions of [Equation 3] below.

$$\begin{matrix}[ Equation 3 ] & \\ wf ( C ) = ∀ G ( \vec{q} ) ∈ C & \end{matrix}$$

$$( \vert G \vert = \vert \vec{q} \vert ) ∧ ( ∀ i , j . i \neq j ⇒ {q}_{i} \neq {q}_{j} )$$

Here, the size |G| of an n-qubit gate G is defined as n. That is, each gate must adhere to its arity, and each gate must act on distinct qubits.

The semantics of C is a mapping [[C]]: C⁽²^{ⁿ}⁾→C⁽²^{ⁿ}⁾ defined as a composition of gate applications within C, where n=|Q|. [[G(\vec{q})]] applies gate G to the qubits in q\vec{ } while leaving the remaining qubits unaffected. For example, the circuit Cₘₐᵢₙ in FIG. 3 reflects the state transitions in Main module of FIG. 1 without action synchronization. Qubits x and g represent Main's state and a temporary value, respectively. Starting from an initial state |ψ₀ [symbol] (30% probability for x=0, 70% probability for x=1), |ψ₁) copies the basis of x to g. Then, |ψ₂ [symbol] and |ψ₃ [symbol] reflect the first and third commands of Main for x=|0 [symbol] and |1 [symbol] , respectively. Overall, Cₘₐᵢₙ transforms the state of two qubits x and g from |ψ₀ [symbol] to |ψ₃ [symbol] (85% probability for x=0, 15% probability for x=1), parallelizing the state transitions of the Main module, excluding the second command.

### Quantum Amplitude Estimation

Quantum Amplitude Estimation (QAE) is a quantum algorithm that estimates the probability of measuring a specific basis state in a given quantum state. For example, consider a circuit Cₚᵣₑₚ acting on an initial state |0 . . . 0 [symbol] _{sys}|0 [symbol] ᵣₑₛ for multiple qubits ‘sys’ and a single qubit ‘res’. QAE efficiently estimates the probability a ∈[0, 1] of measuring |1 [symbol] in the ‘res’ qubit after applying Cₚᵣₑₚ to the initial state |0 . . . 0 [symbol] _{sys}|0 [symbol] ᵣₑₛ. Formally, it is as shown in [Equation 4] below.

$$\begin{matrix}[ Equation 4 ] & \\ a = {P}_{m} ( [ [ {C}_{prep} ] ] ( \vert 0 … 0 {>}_{sys} \vert 0 {>}_{res} ) , res ) & ( 1 )\end{matrix}$$

QAE estimates ‘a’ within an error ε by applying C_{grov} (see below) O(1/ε) times, where each application of C_{grov} corresponds to one quantum sample. Since QAE has an 81% success probability, the algorithm becomes almost certainly successful through a few repetitions and median selection. This method improves speed by a square root factor compared to classical Monte Carlo methods, which require O(1/ε²) samples for the same error ε.

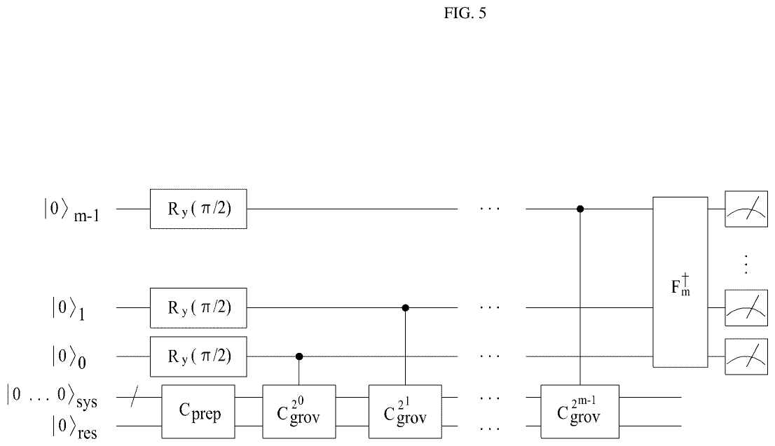

FIG. 5 is a diagram illustrating the overall Quantum Amplitude Estimation (QAE) circuit.

Quantum Amplitude Estimation Circuit: Instead of directly estimating ‘a’ from Cₚᵣₑₚ, QAE estimates θₐ such that sin²(θₐ)=a. The estimation of θₐ includes the following two main components:
Grover operator (C_{grov}): The Grover operator C_{grov} is a unitary operator constructed from Cₚᵣₑₚ, having eigenvalues e^{(±2iθ}^{ₐ}⁾.
Quantum Phase Estimation (QPE): QPE is the process of estimating the eigenvalues of a given unitary matrix.

Within the QAE circuit, the QPE algorithm is applied to C_{grov} to estimate θₐ. The estimated θₐ can then be used to determine the value of ‘a’ through post-processing.

The Grover operator C_{grov} is a key component used in Grover's search algorithm to amplify the probability amplitude of the desired output state. C_{grov} consists of four components and is defined as follows:

$${C}_{grov} = {C}_{orac} {C}_{prep}^{( - 1 )} {C}_{zero} {C}_{prep} .$$

### Here,

$${C}_{prep}^{( - 1 )}$$

is the inverse of Cₚᵣₑₚ, and C_{orac} and C_{zero} are Boolean oracles and zero reflection circuits that perform phase inversion when the result qubit ‘res’ is |1 [symbol] and when ‘sys’ and ‘res’ are both |0 [symbol] , respectively. If Cₚᵣₑₚ is provided, C_{grov} can be easily constructed:

$${C}_{prep}^{( - 1 )}$$

is constructed by applying the gate sequence and rotation angles of Cₚᵣₑₚ in reverse. C_{orac} and C_{zero} are constructed using single-qubit Z gates and multi-controlled Z gates, respectively.

As shown in FIG. 5, QPE requires m additional qubits located in the upper left. To estimate θₐ with m-bit accuracy, C_{grov} is applied 2^{m}−1 times. QPE involves three procedures: First, the states of m qubits are transformed to represent eigenvalue-related terms. For this, m qubits are initialized to an equal superposition state using R_{y}(π/2) gates, and after initializing ‘sys’ and ‘res’ with Cₚᵣₑₚ, several powers of C_{grov} are applied to the m qubits. Second, the m qubits are transformed into eigenvalues through an inverse quantum Fourier transform (|QFT). Finally, the qubits are observed to obtain an integer y∈{0, . . . , 2^{m}−1}, which is the m-bit estimate θ_{ã} of θₐ. From θ_{ã}, ã=sin²(θ_{ã})∈[0, 1] can be estimated.

Example: To estimate the probability of measuring |1 [symbol] ₓ from state |ψ₃ [symbol] using QAE in Cₘₐᵢₙ of FIG. 3, Cₘₐᵢₙ is set as Cₚᵣₑₚ, and qubit x of Cₘₐᵢₙ is designated as ‘res’ for Cₚᵣₑₚ. Then, C_{grov} is constructed and applied O(1/ε) times with QPE to estimate the probability of measuring |1 [symbol] ₓ from state |ψ₃ [symbol] as 0.15 within an error ε.

Analyzing Large Probabilistic Systems with High Accuracy

The object of the present invention is to analyze large probabilistic systems with high accuracy. Existing methods using classical computers do not escape the tradeoff between scalability and accuracy.

State Explosion Problem and Runtime Explosion Problem: FIG. 1 shows a direct matrix multiplication method for probabilistic model checking. However, this approach is only feasible for small models due to the state explosion problem, i.e., the number of states and transitions grows exponentially with model size. For a system where N processes are each in one of M states, the total number of possible states is M^{N}, and the size of the transition matrix becomes M^{N}×M^{N}. This exponential increase in complexity leads to significant computational challenges. Various techniques such as symbolic representation and abstraction have been proposed to mitigate this problem, but they still face exponential state growth.

To avoid a complete exploration of large state spaces, Statistical Model Checking (SMC) estimates model behavior using Monte Carlo simulations. SMC determines whether a finite number of simulations of the system satisfy a given property. This allows SMC to handle larger models while reducing computational requirements and memory usage. However, SMC is not suitable for high-accuracy analysis due to the runtime explosion problem. To achieve low error bounds, the number of samples in SMC must increase quadratically. For example, obtaining results with an error margin of 10⁻⁵ requires billions of samples, which can take weeks or more for analysis. This limitation is particularly critical in safety-critical systems such as transportation and nuclear power plants, where even rare events can have significant impacts.

Classical Approaches to Probabilistic Model Checking: Various approaches for PMC can be divided into two categories: non-statistical methods and statistical methods.

On the one hand, several non-statistical methods have attempted various simplification techniques to address the state explosion problem, but they have fundamental scalability limitations. Symbolic representation methods use decision diagrams (DDs) such as Multi-Terminal Binary Decision Diagrams (MTBDDs) or Multi-Valued Decision Diagrams (MVDDs) to compress state spaces and represent them concisely by exploiting structural symmetries. Abstraction techniques, such as simulation and game-based methods, reduce model size by removing concrete model details irrelevant to the properties of interest. For example, bisimulation identifies and merges indistinguishable states. Model reduction techniques simplify models by removing redundant or less important states, reducing complexity while preserving core probabilities and behaviors. There are also approaches that accelerate abstraction-refinement processes by leveraging important components. However, these approaches still rely on exploring the entire state space, thus having limitations in dealing with complex systems.

On the other hand, several statistical methods, when simulating rare events, were developed to mitigate the runtime explosion problem that occurs, but they do not reduce the asymptotic complexity of sampling. These methods generally use heuristics to identify and focus on important parts of the model's search space to reduce computational costs. For example, MODES uses importance splitting and sampling techniques to guide simulations towards target states. However, these approaches require users to define importance functions or sampling strategies, which can be challenging for non-experts without prior model knowledge.

Therefore, the present disclosure provides a device and method for probabilistic model checking for time-bounded properties using quantum computing. The Quantum Probabilistic Model Checking (QPMC) of the present disclosure demonstrates that it is possible to overcome the tradeoff between scalability and accuracy using quantum computers and analyze large probabilistic systems with high precision.

Generalizing the encoding depicted in FIG. 3, QPMC solves PMC configurations quadratically faster than SMC using quantum computers. QPMC constructs Cₚᵣₑₚ, a core component of QAE, to encode PMC configurations into a quantum circuit, and leverages QAE to estimate the probability that a property is satisfied. This allows for superposing multiple states and performing state transitions in parallel using qubits and quantum gates. Subsequently, QPMC applies Cₚᵣₑₚ to the QAE algorithm to estimate the probability for the PMC configuration. For algorithm T, which transforms a PMC configuration τ into a quantum circuit Cₚᵣₑₚ=T(τ), the following property is proven: THEOREM 3.1 (CORRECTNESS OF QPMC). Let τ be a PMC configuration and res be the result qubit. We have [[τ]]=Pm([[T(τ)]](|0 [symbol] ), res)(1).

This theorem states that after applying the transformed circuit T(τ) to the initial state |0 [symbol] , the result qubit's probability of being |1 [symbol] is equal to (the computed result of PMC). Here, Pm(|ψ [symbol] , q)(v) denotes the probability that qubit q will be |v [symbol] in a given state |ψ [symbol] (refer to background art), and |0 [symbol] is the zero vector. This property allows QPMC to estimate [[τ]] quadratically faster than SMC using QAE.

### Execution Structure of Quantum Probabilistic Model Checking

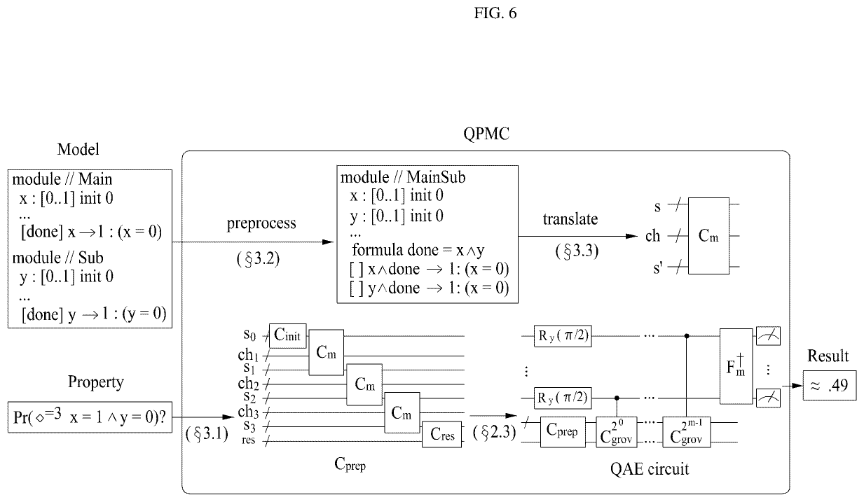

FIG. 6 shows the QPMC process for the example presented in FIG. 1. QPMC transforms a given PMC configuration τ into a quantum circuit Cₚᵣₑₚ and estimates [[t]] through the following four steps.
1. Preprocessing: First, the DTMC model m is preprocessed into a unified system module md_{sys} to address the difficulty of directly encoding state transitions of multiple modules into a quantum circuit. For example, the upper middle part of FIG. 6 shows the preprocessed system module for the model of FIG. 1, which integrates the Main and Sub modules into a single module by resolving synchronized action ‘done’ using formulas and additional guard conditions. This preprocessing, unlike standard approaches, maintains the semantics of the model without exponentially increasing the number of commands, i.e., [[m]]=[[md_{sys}]].
2. Model Translation: Second, the system module md_{sys} is translated into a quantum circuit Cₘ that reflects state transitions. This circuit loads the probability distribution of the current state s into qubit s and reflects the next state s′ using choice qubits ch. For the set S of all possible states, the state probability distribution can represent and process multiple states in parallel using log₂(|S|) qubits for s and s′. For example, the upper right of FIG. 6 shows the circuit Cₘ for the preprocessed model of FIG. 1, encoding the current values and next values of variables x and y into state qubits s and s′ respectively.
3. Property Translation: Third, Pr(♦=tω) is translated into a quantum circuit Cₚᵣₑₚ=T(τ) that reflects the computation of [[(m, Pr(♦=t ω))]] as follows:
(1) Initialization Circuit Cᵢₙᵢₜ=Tᵢₙᵢₜ(md_{sys}): This loads the probability distribution of the initial state, which is a one-hot vector of the initial state. For example, FIG. 6 shows the initialization circuit Cᵢₙᵢₜ for the model of FIG. 1, encoding the initial state {x [symbol] 0, y [symbol] 0} into qubit so.
(2) Transition Circuit Tᵣₑₚ(Cₘ, t): This applies the circuit Cₘ ‘t’ times. For example, Tᵣₑₚ(Cₘ, 3) in FIG. 6 applies Cₘ three consecutive times.
(3) Result Circuit Cᵣₑₛ=Tᵣₑₛ(ω, t): This encodes the probability of reaching the target state ω after ‘t’ transitions into the qubit ‘res’. For example, Cᵣₑₛ in FIG. 6 encodes the probability that x=1 ∧y=0 is satisfied. Circuits Cᵢₙᵢₜ and Cᵣₑₛ are described by the following mappings, as they form the basis of state ‘s’. Furthermore, both circuits are defined by classical operations such as arithmetic and comparison, making them easy to construct from classical logic gate representations:

$$\begin{matrix}[ Equation 5 ] & \\ {\vert 0 〉}_{{s}_{0}} {↦}^{〚 {C}_{init} 〛} {\sum }_{( s ↦ λ ) ∈ {π}_{0} ( {md}_{sys} )} \sqrt{λ} \vert s {〉}_{{s}_{0}} \text{?} \vert s {〉}_{{s}_{t}} \vert 0 {〉}_{res} {↦}^{〚 {C}_{res} 〛} \vert s {{〉}_{{s}_{t}} 〚 X 〛}^{{1}_{{s}_{ω}} ( s )} \vert 0 {〉}_{res} & \end{matrix}$$

On the other hand, Tᵣₑₚ(Cₘ, t) is an appropriate quantum circuit involving superposition, which cannot be expressed by classical circuits. Applying these sub-circuits of Cₚᵣₑₚ results in the qubit ‘res’ representing [[τ]], meaning that the probability of reaching the target state ω after ‘t’ transitions in τ is equal to the probability of measuring |1 [symbol] in ‘res’.
4. Property Estimation: Finally, QPMC uses the QAE algorithm to estimate from ‘res’ the probability of measuring |1 [symbol] , which corresponds to [[τ]]. For this, QPMC applies the transformed circuit Cₚᵣₑₚ to the QAE algorithm.

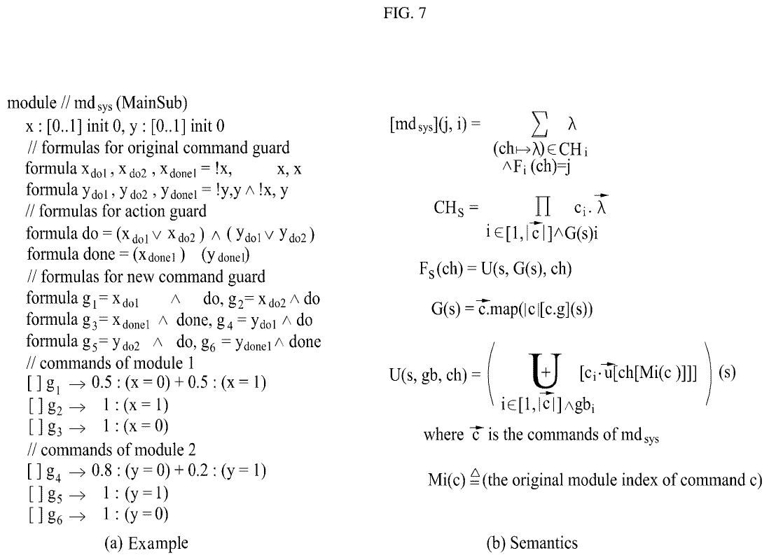

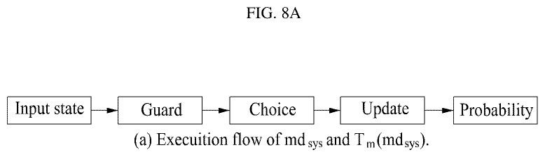

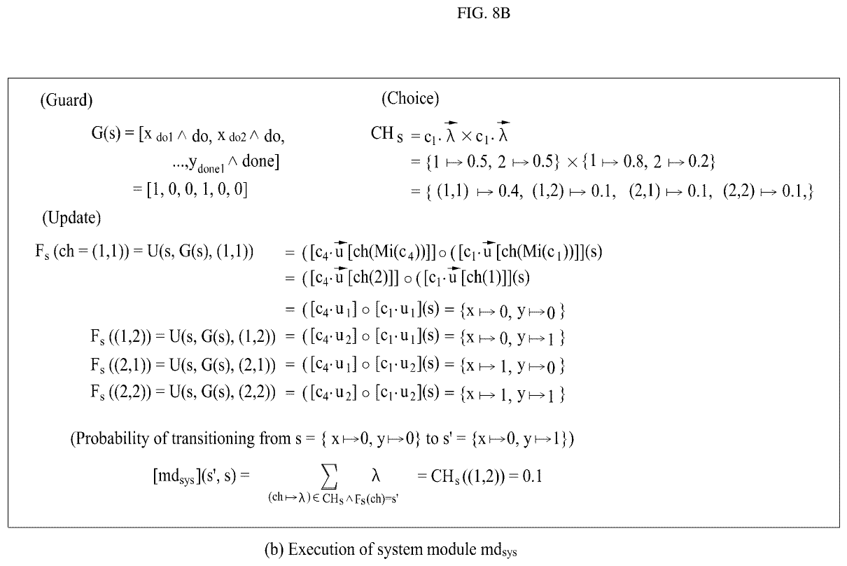

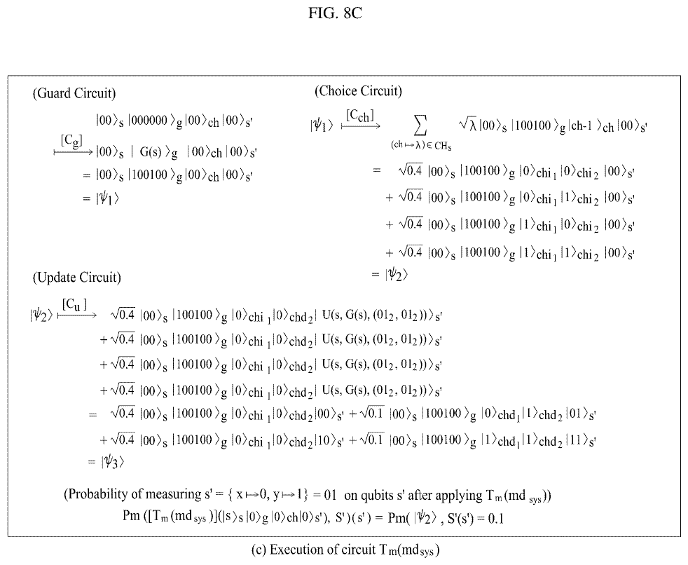

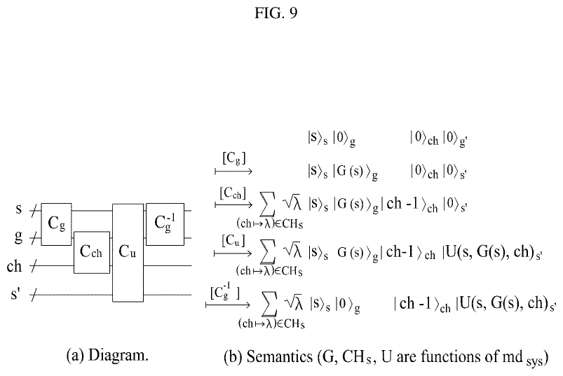

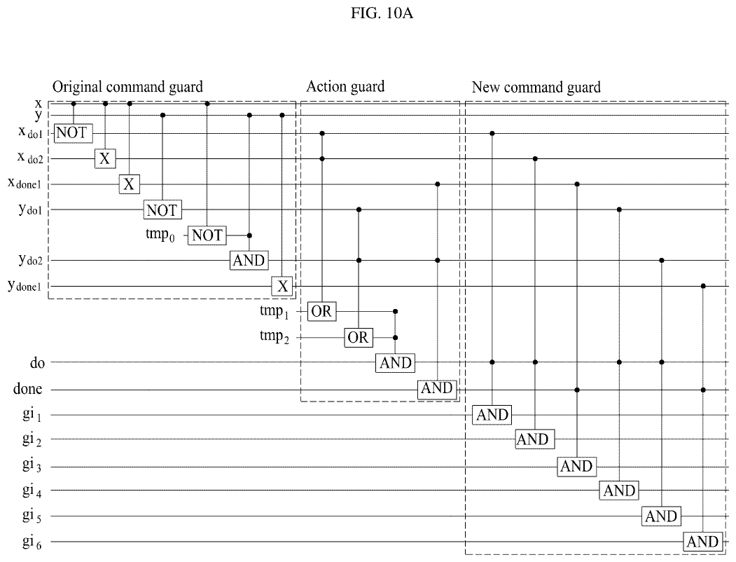

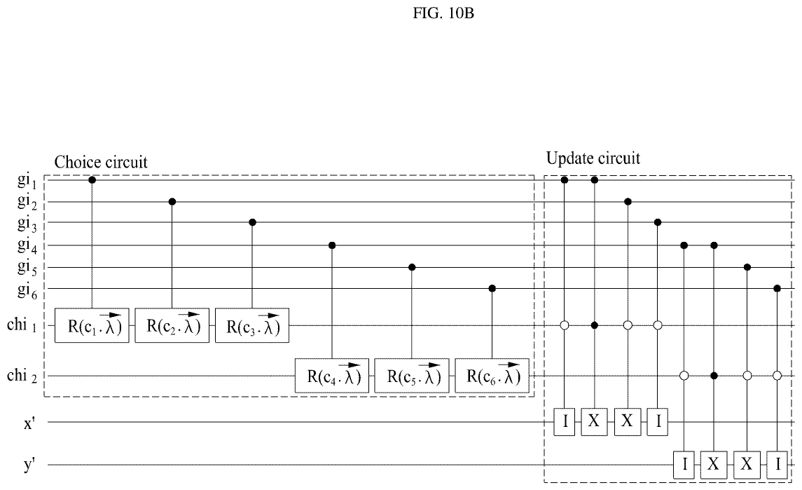

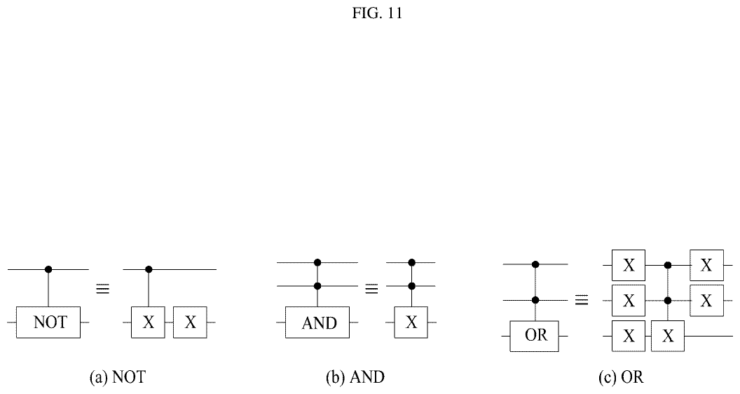

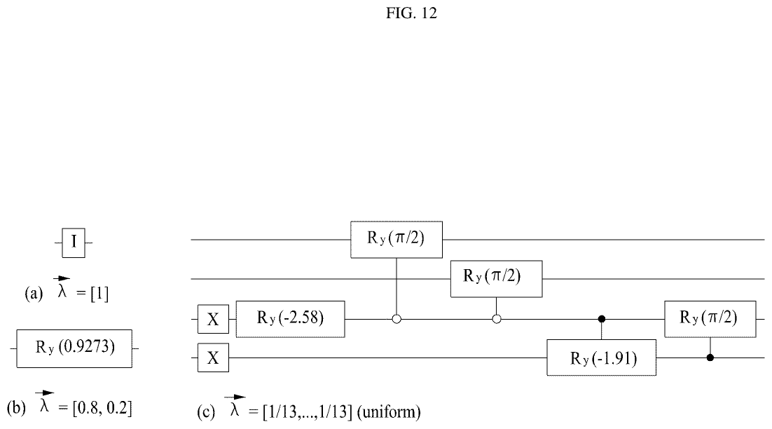

FIG. 7 is a diagram showing the preprocessed system module for the model of FIG. 1. FIG. 8A is a diagram illustrating the execution of the preprocessed system module of FIG. 7. FIG. 8B is a diagram illustrating the execution of the preprocessed system module of FIG. 7. FIG. 8C is a diagram illustrating the execution of the preprocessed system module of FIG. 7. FIG. 9 is a diagram illustrating the model translation for the preprocessed system module of FIG. 7. FIG. 10A is a diagram illustrating the quantum circuit for the preprocessed system module of FIG. 7. FIG. 10B is a diagram illustrating a quantum circuit for the preprocessed system module of FIG. 7. FIG. 11 is a diagram additionally illustrating FIG. 10A. FIG. 12 is a diagram additionally illustrating FIG. 10B.

### Preprocessing

QPMC's preprocessing merges all modules into a unified system module “md_{sys}” to simplify inter-module synchronization. For the preprocessing algorithm “Tₚᵣₑ” that transforms a DTMC model into a system module, we prove that “Tₚᵣₑ” preserves the transition matrix: LEMMA 3.2. For every model m, we have [[m]]=[[Tₚᵣₑ(m)]].

Algorithm: Algorithm 1 in [Table 1] below presents “Tₚᵣₑ”, which integrates synchronized commands from different modules and encodes inter-module synchronization as additional guard conditions in the system module. (1) “Tₚᵣₑ” generates a dictionary that groups commands by action name within each module using SyncInfo (line 2). (2) “Tₚᵣₑ” copies all variables from m to md_{sys}, renames them using formulas for synchronization, and declares them (lines 4-8). Here, GetId returns a unique identifier based on the module name, action name, and command index, and AddFormula(md_{sys}, n, g) adds a new formula to md_{sys} with name n and guard condition g. (3) “Tₚᵣₑ” then constructs formulas that determine action activation (lines 9-13). An action is activated when all modules have an enabled command for that action. (4) Finally, “Tₚᵣₑ” extends the guard conditions of the original commands to encode synchronization (lines 14-20).

TABLE 1
Algorithm 1 Preprocessing the given DTMC model m into md_{sys}.

| 1: | function Tₚᵣₑ(m : Model) | | | | | |
|---|---|---|---|---|---|---|
| 2: | \| | info ← SYNCINFO(m) | | | | [symbol] Dictionary {Module : {Action : [symbol] } |
| 3: | \| | md_{sys} ← empty module md | | | | |
| 4: | \| | md_{sys}, \vec{d} ← (m.md₁, \vec{d} [symbol] . . . [symbol] m.mdₙ, \vec{d} ) | | | | [symbol] Add original decls |
| 5: | \| | for i ∈ [1, \|m.\vec{md}\|] do | | | | [symbol] Add original guards |
| 6: | \| | \| | for (a [symbol] \vec{c}) ∈ info[mdᵢ] do | | | |
| 7: | \| | \| | \| | for j ∈ [1, \|\vec{c}\|] do | | |
| 8: | \| | └ | └ | └ | ADDFORMULA(md_{sys}, GETID(mdᵢ, a, j), \vec{c}[j].g) | |
| 9: | \| | for a ∈ m.Action do | | | | [symbol] Add action guards |
| 10: | \| | \| | al ← [ ] | | | |
| 11: | \| | \| | for i ∈ [1, \|m.\vec{md}\|] do | | | |
| 12: | \| | \| | └ | al.add(∨_{j∈\|info[md}_{ᵢ}_{][a]\|} GETID( mdᵢ, a, j)) | | |
| 13: | \| | └ | ADDFORMULA(md_{sys}, a, (∧_{e∈al} e)) | | | |
| 14: | \| | k ← 1 | | | | |
| 15: | \| | for i ∈ [1, \|m.\vec{md}\|] do | | | | [symbol] Add sync-resolved commands |
| 16: | \| | \| | for (a [symbol] \vec{c}) ∈ info[mdᵢ] do | | | |
| 17: | \| | \| | \| | for j ∈ [1, \|\vec{c}\|] do | | |
| 18: | \| | \| | \| | \| | ADDFORMULA(md_{sys}, gₖ, GETID(mdᵢ, a, j) ∧ a) | [symbol] New guard |
| 19: | \| | \| | \| | \| | md_{sys}.\vec{c}[k] ← ([⊥] gₖ → probabilistic updates of \vec{c}[j]) | [symbol] New command |

| | | | | | |
|---|---|---|---|---|---|
| 20: | \| | └ | └ | └ | k ← k + 1 |

| | | |
|---|---|---|
| 21: | └ | return md_{sys} |

For example, FIG. 7(a) shows the preprocessed system module “md_{sys}” for the model depicted in FIG. 1. The module “md_{sys}” includes variables “x” from the Main module and “y” from the Sub module, and command guard conditions are denoted as X_{do1}, X_{do2}, X_{done1}, etc. For instance, X_{do1} represents the guard condition of the first command with action “do” in Main. Formulas “do” and “done” represent action activations, and g₁, g₂, etc., represent extended guard conditions encoding synchronization. Commands reflect the original model, including these extended guard conditions.

Semantics: The semantic definition of the preprocessed system module differs from that of the original model. As shown in FIG. 2(b), the semantics [[m]] of the original model m executes synchronized commands sequentially within each module. Each module identifies activated commands and applies the corresponding updates in order. Thus, [[m]](j,i) is defined as the product of local transition probabilities for each module.

In contrast, the semantics [[md_{sys}]] of the preprocessed system module “md_{sys}” is based on executing synchronized commands in parallel to replicate the individual behaviors of the original modules. Specifically, it identifies all activated commands and applies updates simultaneously according to three main functions (refer to FIG. 7(b)): (1) Guard function G, which identifies activated commands. (2) Choice function CHᵢ, which constructs a joint probability distribution over all possible updates from state i. (3) Update function U, which computes the next state for a given set of updates. Thus, [[md_{sys}]](j, i) is defined as the sum of probabilities of choices that transition from state i to j.

Example: FIG. 8A shows the execution of “md_{sys}” as depicted in FIG. 7(a). Consider the transition probability from state s={x [symbol] 0, y [symbol] 0} to s′={x [symbol] 0, y [symbol] 1}.

Guard: Since !x and !y are true, the activated commands are identified as c₁ and c₄ by G(s)=[1,0,0,1,0,0].

Choice: The possible choices from state s are determined by CHₛ=c₁·λ×c₄·λ, generating four potential choices associated with specific probabilities from state s. For example, CHₛ((1, 2))=0.1 means that the first update of c₁ and the second update of c₄ are chosen with a probability of 0.1.

Update: For each choice ch: N², ch(1) and ch(2) represent the first and second selected update indices for the activated commands, and the next state from state s is computed as Fₛ(ch)=U(s, G(s), ch). For example, activated commands c₁ and c₄ apply updates ch(Mi(c₁))=ch(1) and ch(Mi(c₄))=ch(2), respectively. Thus, Fₛ((1, 2))=U(s, G(s), (1, 2)) generates the next state {x [symbol] 0, y [symbol] 1} by applying the first update of c₁ and the second update of c₄ for state s.

Finally, the transition probability from state s to s′ is determined by summing the probabilities of all choices in CHₛ that transition to s′. This probability is equal to [[md_{sys}]](s′, s)=CHₛ ((1, 2))=0.1, which is the same as [[m]](s′, s) of the original model m.

### Model Translation

QPMC then translates the system module md_{sys} into a quantum circuit Cₘ to encode [[md_{sys}]]. Cₘ receives the current state and generates the probability distribution of the next state by superposing parallel executions of activated transitions using qubits for the current state, guards, choices, and next state. For Tₘ, which translates a system module into a quantum circuit, we prove the following property: LEMMA 3.3. Let md_{sys} be a system module, and s, g, ch, s′ the qubits representing its current state, guards, choices, and next state, respectively. We have:

$${{{{∀ s , {s}^{′} ∈ S , \text{?} {md}_{sys} \text{?} ( {s}^{′} , s ) = Pm ( \text{?} {T}_{m} ( {md}_{sys} ) \text{?} ( \vert s 〉}_{s} \vert 0 〉}_{g} \vert 0 〉}_{ch} \vert 0 〉}_{{s}^{′}} ) , {s}^{′} ) ( {s}^{′} ) \qquad [ Equation 6 ]$$

This lemma states that after applying the translated circuit Tₘ(md_{sys}) to the input state |s [symbol] ₛ |0 [symbol] _{g} |0 [symbol] _{ch} |0 [symbol] _{s′}, the probability of measuring s′ in the next state qubit s′ is equal to [[md_{sys}]](s′, s).

FIG. 9 is an overview of the circuit Cₘ=Tₘ (md_{sys}) that reproduces the transitions of md_{sys}. Cₘ consists of four circuits encoding G, CHₛ, U, and G⁻¹:
1. Guard Circuit C_{g}=T_{g}(md_{sys}): This encodes G, which evaluates the guard conditions for state s and encodes the results into guard qubits g.
2. Choice Circuit C_{ch}=T_{ch}(md_{sys}): This encodes CHₛ, which generates a superposition state in choice qubits ch representing all possible update combination choices and their probabilities from the current state s.
3. Update Circuit Cᵤ=Tᵤ(md_{sys}): This encodes U, which computes and encodes the next state s′ into s′ based on the selected update combination.
4. Guard Uncomputation Circuit

$${C}_{g}^{- 1} = {T}_{ginv} ( {md}_{sys} ) :$$

This encodes G⁻¹, which restores guard qubits g to the initial state |0 [symbol] , allowing g to be reused for subsequent state transitions.

These four circuits, as a sequence of operations, map each basis state Is) of s to a probability distribution over the next state s′. As described earlier, this mapping from basis states fully describes the circuit for parallel processing of states.

Guard: The circuit C_{g} encodes G, which evaluates the guards of all commands. [[C_{g}]] transforms the input state |s [symbol] ₛ |0 [symbol] _{g} to the output state |s [symbol] ₛ |G(s) [symbol] _{g}. Since G consists of classical operations, C_{g} can be easily constructed, similar to how Cᵢₙᵢₜ and Cᵣₑₛ were constructed. For example, FIG. 10A shows the circuit C_{g} for the system module md_{sys} of FIG. 7(a). This circuit replicates the guard functions of md_{sys} onto guard qubits, reflecting the expression of each formula in quantum gates. Here, NOT, AND, and OR represent the corresponding classical logic gates (refer to FIG. 11).

Furthermore, after reproducing state transitions using C_{ch} and Cᵤ, QPMC restores the state of g to the initial state |0 [symbol] using

$${C}_{g}^{- 1} .$$

This allows g to be reused for subsequent state transitions. Unlike classical bits, quantum bits cannot be overwritten, thus requiring uncomputation. The uncomputation process is performed by applying the gates of C_{g} in reverse order, which(1) is constructed by a circuit with classical semantics, and (2) can be safely performed without affecting other qubits if the qubits used in the construction are still available.

Choice: The circuit C_{ch} encodes CHₛ, which enumerates all possible choices and their probabilities for the current state s. [[C_{ch}]] transforms the input state |gb [symbol] _{g} |0 [symbol] _{c}h into a superposition state Σ(ch→λ)∈CH_s √λ |gb [symbol] _{g} |ch−1 [symbol] _{ch}, where gb is the Boolean vector of guard results generated by C_{g}. This circuit connects individual circuits that set choices for each activated command.

For example, the left side of FIG. 10B shows the circuit C_{ch} translated from md_{sys}. The three leftmost gates set probabilities for choice qubit chi₁ for commands c₁, c₂, c₃ of md_{sys} when gi₁, gi₂, gi₃ are in state |1 [symbol] , respectively. Here, R(λ) denotes a gate that sets a probability distribution λ on a qubit.

Update: The circuit Cᵤ encodes U, which generates the next state from the current state, guard conditions, and probabilistic choices. [[Cᵤ]] transforms the input state |s [symbol] ₛ |gb [symbol] _{g} |ch [symbol] _{ch} |0 [symbol] _{s′} to the output state |s [symbol] ₛ |gb [symbol] _{g} |ch [symbol] _{ch} |U(s, gb, ch))_{s′}. Since U consists of classical operations, Cᵤ can be easily constructed.

For example, the right side of FIG. 10B shows the circuit Cᵤ for the system module md_{sys} of FIG. 7(a). For the two choices of the first command c₁, the two leftmost gates generate the next state, and the third gate performs for the single choice of the second command c₂. Specifically, the second gate

$${Ct}^{{11}_{2}} ( X ) ( [ {g}_{i 1} , {chi}_{i 1} ] , {x}^{′} )$$

replicates the second update of c₁ (x=1) by updating the basis of x′ from |0 [symbol] to |1 [symbol] when both guard qubit gᵢ₁ and choice qubit chiᵢ₁ are in state |1 [symbol] .

Example: FIG. 8C shows the execution of Tₘ(md_{sys}) for md_{sys} presented in FIG. 7(a). Here, the focus is on the probability of measuring the next state s′={x→0, y→1}=01₂ in qubit s′ after applying Cₘ from the initial state s={x→0, y→0}=00₂. Ancillary qubits are omitted for brevity.

The initial quantum state is constructed as follows: In |00 [symbol] ₛ |000000 [symbol] _{guard} |00 [symbol] _{choice} |00 [symbol] _{s′}, 00 [symbol] ₛ represents the initial state s, |000000 [symbol] _{guard} represents the guard qubits gi₁ to gi₆ for six commands, and |00 [symbol] _{choice} represents the choice qubits chi₁ and chi₂ for two activated commands, and |00 [symbol] _{s′} represents the next state s′, all shown in binary.

Guard: The C_{g} operation identifies activated commands and transforms |00 [symbol] ₛ |000000 [symbol] _{guard} to |00 [symbol] ₛ |100100 [symbol] _{guard}. This indicates that commands c₁ and c₄ are activated.

Choice: The C_{ch} operation superposes the possible choices of the activated commands. It maps |100100 [symbol] _{guard} |0 [symbol] _{chi1}|0 [symbol] _{chi2} to |100100 [symbol] _{guard} (√0.4 |0 [symbol] _{chi1}|0 [symbol] _{chi2}+ . . . +√0.1 |1 [symbol] _{chi1}|1 [symbol] _{chi2}). This generates four possible choices along with their probabilities. For example, the last term √0.1 |1 [symbol] _{chi1}|1 [symbol] _{chi2} implies that there is a probability of 0.1 that both the second update of the first activated command (chi₁) and the second update of the second activated command (chi₂) are chosen.

Update: The Cᵤ operation determines the next state for each choice |ch_1 [symbol] _{chi1} |ch_2 [symbol] _{chi2} based on the bases of s, guard, and choice. For example, Cᵤ changes the basis of s′ from |00 [symbol] to |01 [symbol] in the state |00 [symbol] ₛ |100100 [symbol] _{guard} |0 [symbol] _{chi1}|1 [symbol] _{chi2}|00 [symbol] _{s′}, and changes it from |00 [symbol] to |10 [symbol] in the state |00 [symbol] ₛ |100100 [symbol] |1 [symbol] _{chi1}|0 [symbol] _{chi2}|00 [symbol] _{s′}.

The probability of measuring |01 [symbol] _{s′} in the output state is determined by summing the probabilities of all basis states that include |01 [symbol] in s′. In this example, there is only one basis |00 [symbol] ₛ . . . |0 [symbol] _{chi1}|1 [symbol] _{chi2}|01 [symbol] _{s′} with a probability of 0.1, which is equal to [[md_{sys}]](s′, s) as shown in FIG. 8B.

Note that, although not shown, the guard uncomputation circuit

$${C}_{g}^{- 1}$$

resets the guard qubits g to |000000 [symbol] _{guard} after the update operation, allowing them to be reused without affecting the probability measurement of s′.

### Qubit Count Optimization Through Uncomputation

While C_{τ}=T(τ) accurately solves the PMC configuration τ, as the number of transition steps increases, the number of required state qubits ‘s’ and choice qubits ‘ch’ grows linearly, making management difficult. Qubits are a critical resource in quantum computing, so this problem is very important.

To address this, we focus on minimizing the number of state qubits. This is because state qubits, unlike choice qubits, can be uncomputed and recycled. QPMC utilizes a batch recycling strategy to reduce the number of state qubits from O(t) to O(√t). This is because the number of state qubits is generally greater than choice qubits, and choice qubits are shared across multiple commands, thus significantly reducing the overall number of qubits. Specifically, we designed a qubit optimization transformation algorithm Tₒₚₜ that satisfies the following property: THEOREM 4.1 (CORRECTNESS OF QPMC WITH QUBIT OPTIMIZATION). Let τ be a PMC configuration and res be the result qubit. We have [[τ]]=Pm([[Tₒₚₜ(τ)]] (|0 [symbol] ), res)(1).

State Qubit Recycling: Similar to the uncomputation of guard qubits g, state qubits s can also be uncomputed and recycled. This helps reduce the total number of state qubits required for multiple transitions. Qubits can be uncomputed when (1) their state is generated by a circuit with classical semantics, and (2) the input qubits used to generate that state are still available. Since the update circuit Cᵤ operates classically, its results can be uncomputed and recycled if the input qubits are available when the state qubits are no longer needed.

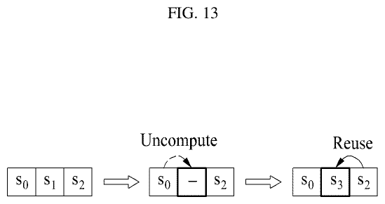

For example, FIG. 13 illustrates the recycling of state qubit S₁ during a transition from s₀ to s₃. Other qubits are omitted here. (1) Assume the transitions from s₀ to s₁ and s₂ are complete. (2) Since s₁ is no longer needed, it can be safely uncomputed based on the following two properties: generating s₁ from s₀, g, and ch₁ (omitted in FIG. 13) is classical, and S₀, g, and ch₁ are still available. The uncomputation of s₁ is achieved by applying the

$${C}_{u}^{- 1}$$

circuit to the same input qubits s₀, g, ch₁. (3) Subsequently, the uncomputed state qubit s₁ can be reused in other operations.

Batch Recycling: However, immediately recycling unnecessary state qubits is not always efficient. For example, in FIG. 13, s₂ cannot be recycled because the previous state s₁ is no longer used. Such immediate recycling leads to a large increase in the number of non-recycled state qubits.

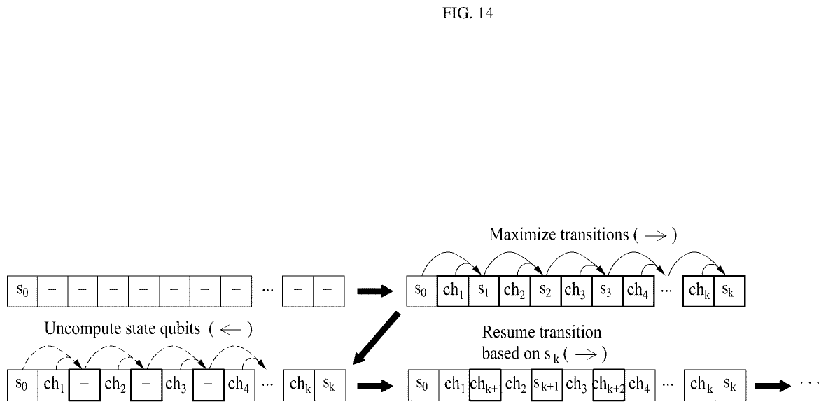

To improve qubit efficiency, QPMC uses a batch recycling strategy, as shown in FIG. 14, to reduce the number of non-recycled state qubits and maximize overall qubit utilization. Specifically, this strategy proceeds as follows: (1) Transition (→): State qubits from s₁ to sₖ and corresponding input choices are computed sequentially, maximizing the use of all available qubits. Here, k is the limit of achievable transitions. (2) Uncomputation (←): State qubits from s₁ to sₖ₋₁ are uncomputed in reverse order, preserving sk for the next transition. Choices cannot be uncomputed as they are evaluated by classical operations. (3) Subsequently, state qubits from s₁ to sₖ₋₁ can be reused for subsequent transitions (chₖ₊₁, sₖ₊₁, . . . ) from the last state qubit sₖ. This process is repeated until the final state qubit sₜ is reached.

Space Complexity of State Qubits: By repeatedly applying batch recycling, the optimized circuit reaches sₜ using only O(√t) state qubits. This is analyzed as follows:

Let n (t) be the minimum number of qubits required to complete ‘t’ transitions through batch recycling. Assume transitions are divided into ‘b’ batches, and the i-th batch has tᵢ transitions. After all transitions are completed, n (t) qubits are divided into ‘t’ choice qubits and ‘b’ state qubits. Choice qubits are essential at each step and cannot be uncomputed, so ‘t’ choice qubits are needed. On the other hand, after each batch, only one non-recycled state qubit remains, so the total number of state qubits is ‘b’. Therefore, [Equation 7] below is derived.

$$n ( t ) = CH \times t + ST \times b \qquad [ Equation 7 ]$$

Here, CH and ST represent the size of a single choice qubit and a state qubit, respectively.

In this equation, an upper bound for the number of batches ‘b’ can be calculated proportionally to the minimum number of transitions tᵢ in each i-th batch. In the first batch, enough choice qubits and ‘b’ state qubits are used, so t₁ is at least ‘b’. After ‘b’ transitions, ‘b’ choice qubits are used, but t−b choice qubits are not used. Therefore, more transitions can be performed in the first batch using these idle choice qubits, which means t₁≥b. In the second batch, b−1 state qubits from the first batch are uncomputed, so t₂ is at least b−1. Generalizing this, we get [Equation 8] below.

$$b - i + 1 \leq {t}_{i} \qquad [ Equation 8 ]$$

Summing the inequalities yields the result as shown in [Equation 9] below.

$$\frac{b ( b + 1 )}{2} = {{\sum }_{i = 1}}^{b} ( b - i + 1 ) \leq {{\sum }_{i = 1}}^{b} {t}_{i} = t \qquad [ Equation 9 ]$$

Therefore, b∈O(√t), and we need O(√t) state qubits.

### Proof of Correctness

THEOREM 3.1 (CORRECTNESS OF QPMC). Let τ be a PMC configuration and res be the result qubit. We have [[τ]]=Pm([[T(τ)]](|0 [symbol] ), res)(1).

The core idea of this proof is to leverage the fact that the transition circuit represents the transition probability matrix and correctly accumulates transition probabilities. Specifically, let τ=(m, Pr(♦=tω)), let π₀ be the initial state distribution of model m, let md_{sys}=Tₚᵣₑ(m), and let s₀ and sₜ be the qubits for the initial and final states after t transitions. Then, we have [Equation 10] below.

$$\begin{matrix}pm ( \text{?} T ( τ ) ( \vert 0 〉 ) , res ) ( 1 ) = Pm ( ( \text{?} {T}_{res} ( ω , t ) \text{?} \cdot \text{?} {T}_{rep} ( {T}_{m} ( {md}_{sys} ) , t ) \text{?} \cdot \text{?} {T}_{init} ( {md}_{sys} ) \text{?} ( \vert 0 〉 ) , res ) ( 1 ) & ( \text{?} by definition of T ) \\ = Pm ( ( \text{?} {T}_{res} ( ω , t ) \text{?} \cdot \text{?} {T}_{rep} ( {T}_{m} ( {md}_{sys} ) , t ) \text{?} ( \vert {ψ}_{0} 〉 ) , res ) ( 1 ) & ( \text{?} by property of {T}_{init} ) \\ = Pm ( ( \text{?} {T}_{res} ( ω , t ) \text{?} ( \vert {ψ}_{1} 〉 ) , res ) ( 1 ) & ( \text{?} by Lemma 5.1 ) \\ = Res ( ω , \text{?} {md}_{sys} {\text{?}}^{t} {π}_{0} ) & ( \text{?} by Lemma 5.2 ) \\ = Res ( ω , \text{?} m {\text{?}}^{t} {π}_{0} ) & ( \text{?} by Lemma 5.2 ) \\ = \text{?} r \text{?} , & ( \text{?} by the definition of \text{?} r \text{?} )\end{matrix} \qquad \{ Equation 10 ]$$

Here, |ψ₀ [symbol] =[Tᵢₙᵢₜ(md_{sys})] and |ψ₁ [symbol] =[Tᵣₑₚ(Tₘ(md_{sys} [symbol] , t)] satisfy Pm(|ψ₀ [symbol] , s₀)=π₀ and Pm(|ψ₁ [symbol] , sₜ)=[[md_{sys}]]^{t}π₀, respectively.

First, the second step trivially holds by the definition of Tᵢₙᵢₜ(md_{sys}). For the third step, Lemma 5.1 is proven to show Pm(|ψ₁ [symbol] , sₜ)=[[md_{sys}]]^{t} π₀.

LEMMA 5.1. Let md_{sys} be a system module, π a state distribution, t∈N. If the quantum state (|ψ [symbol] satisfies Pm((|ψ [symbol] , s₀)=π,
then:

$${{{{\text{?} {md}_{sys} {\text{?}}^{t} π = Pm ( \text{?} {T}_{rep} ( {T}_{m} ( {md}_{sys} ) , t ) \text{?} ( \vert ψ 〉 \vert 0 〉}_{{ch}_{1}} \vert 0 〉}_{{s}_{1}} … \vert 0 〉}_{{ch}_{t}} \vert 0 〉}_{{s}_{t}} ) , {s}_{t} ) ,$$

where chᵢ and sᵢ, i>0, are qubits that do not belong to |ψ [symbol] .

This lemma states that after applying [[Tᵣₑₚ(Tₘ(md_{sys}), t)]] to |ψ [symbol] |0 [symbol] _{ch1} |0 [symbol] ₛ₁ . . . |0 [symbol] _{cht} |0 [symbol] ₛₜ, the final state sₜ represents the probability after t transitions of the system module md_{sys} accurately encodes the distribution. This is proven by mathematical induction on t, and the core of the base case proof for a single state transition uses Lemma 3.3.

Next, in the fourth step, Lemma 5.2 is proven to show that the final result circuit encodes the desired probability into the result qubit ‘res’: LEMMA 5.2. Let Pr(⋄^{=t} ω) be a property and π be a state distribution. If the input quantum state |ψ [symbol] satisfies Pm(|ψ [symbol] , sₜ)=π and res is qubit that belong to |ψ [symbol] with initial state |ψ [symbol] ᵣₑₛ, the: Res(ω, π)=Pm([[Tᵣₑₛ(ω, π)]](|0 [symbol] ), res)(1).

This lemma indicates that after applying Tᵣₑₛ(ω, t) to |ψ [symbol] , the probability of the target state ω after t transitions is accurately encoded into the probability of measuring |1 [symbol] in the result qubit ‘res’. This is proven by expanding the definition of Tᵣₑₛ(ω, t).

Finally, in the fifth step, Lemma 3.2 is proven to show that the semantics of the system module md_{sys} are equivalent to the semantics of the original model m: LEMMA 3.2. For every model m, we have [[m]]=[[Tₚᵣₑ(m)]]. This lemma is proven by expanding the semantics of the resulting system module md_{sys} and leveraging the fact that in the original model m, only one command per module is activated at each step. Therefore, the aggregated result from the semantics [[md_{sys}]] of the system module is identical to that of the original model [[m]].

Proof of Correctness for Optimization: THEOREM 4.1 (CORRECTNESS OF QPMC WITH QUBIT OPTIMIZATION). Let τ be a PMC configuration and res be the result qubit. We have [[τ]]=PM([[Tₒₚₜ(τ)]](|0 [symbol] ), res)(1).

This proof is similar to the proof of Theorem 3.1, but differs in that it uses Lemma 5.3 instead of Lemma 5.1 for the state of the system module md_{sys} transition. We define Tₒₚₜᵣₑₚ as an optimized version of Tᵣₑₚ and define a function FreeQubits that provides a list of auxiliary qubits used in the batch recycling strategy.

LEMMA 5.3. Let md_{sys} be a system module and x a state distribution. If the input quantum state |ψ [symbol] satisfies Pm(|ψ [symbol] , s₀)=π, and sₜ and β=FreeQubits(Cₘ, t) are qubits and free qubits respectively, which do not belong to |ψ [symbol] , then

$${{\text{?} {md}_{sys} {\text{?}}^{t} π = Pm ( \text{?} {T}_{optrep} ( {T}_{m} ( {md}_{sys} ) , t ) \text{?} ( \vert ψ 〉 \vert 0 〉}_{β} \vert 0 〉}_{{s}_{t}} ) , {s}_{t} ) .$$

This lemma is proven in two steps: (1) dividing ‘t’ transitions into ‘n’ batches such that the sum of transitions performed in each batch equals ‘t’ (i.e.,

$$t = {\sum }_{( i = 1 )}^{n} {t}_{i} ,$$

where tᵢ denotes the number of transitions in the i-th batch). (2) proving that the state transition of each batch corresponds to tᵢ transitions of the system module through qubit recycling.

To prove the second step, we clearly classify free qubits in each batch into state qubits and choice qubits. This allows for safely applying forward transition (→) and reverse uncomputation (←) for each type of qubit in each batch. Subsequently, all state qubits uncomputed by reverse uncomputation become free qubits in the next batch.

### Implementation

We implement QPMC's transformation algorithm T and optimized transformation algorithm Tₒₚₜ using the Qiskit framework for quantum computing. The implementation utilizes Qiskit's classical circuit components (e.g., adders) and arbitrary state preparation components to construct R(λ) gates. It also automatically inserts uncomputation circuits using Unqomp.

For the optimized transformation algorithm Tₒₚₜ, a binary search is initiated to determine the minimum number of auxiliary qubits required to complete ‘t’ transitions using batch recycling. Then, forward transitions (→) and reverse uncomputation (←) are repeatedly applied using these qubits until all ‘t’ transitions are completed.

Verification: To verify the accuracy of the QPMC implementation, the end-to-end simulation results of QPMC were compared with results obtained from the PRISM model checker. The circuit Cₚᵣₑₚ generated by T is connected to Qiskit's QAE algorithm, and the entire model verification process is simulated via classical simulation.

Considering the qubit count limitations of classical simulation, small DTMC models up to 29 qubits are tested. For example, for models like those in [Table 2] below, the property Pr(♦=t x=1 ∧y=1) is considered for t=1, 2.

TABLE 2

| module | module |
|---|---|
| x: [0..1] init 0 | y: [0..1] init 0 |
| [do] !x → 0.4: (x = 0) + 0.6: (x = 1) | [do] 1 → 0.3: (y = 0) + 0.7: (y = 1) |
| [do] x → 0.25: (x = 0) + 0.75: (x = 1) | |

It was confirmed that the probabilities estimated by QPMC were in very good agreement with the exact probabilities calculated by PRISM, matching up to 10⁻¹⁰ in all tested cases.

According to the present disclosure, QPMC achieves a quadratically lower time complexity than SMC for the same error bounds and confidence levels. Furthermore, QPMC's qubit optimization technique results in an average 37% reduction in qubit requirements across benchmarks.

### Time Complexity Analysis

The performance of QPMC is compared with SMC. Both methods handle large-scale models that pose challenges for non-statistical approaches and provide probabilistic results with improved accuracy as computation time increases. For the same error bound ε(<1) and confidence level, QPMC requires quadratically fewer samples than SMC. For analysis, let m be a DTMC model, S be the set of states of m, and t be the number of transition steps.

The time complexity of QPMC is O(tlml/ε). This includes: (1) O(1/ε): the number of samples (circuit executions) required for the error bound & in the QAE algorithm, and (2) O(t|m|): the single circuit execution time derived from ‘t’ state transitions and the number of qubits O(|m|) required in the transition circuit Cₘ.

The time complexity of SMC is O(t|m|/ε²). This includes: (1) O(1/ε²): the number of samples required for the error bound & from the Chernoff-Hoeffding bound, and (2) O(t|m|): the sampling execution time derived from ‘t’ state transitions and the sampling execution time O(|m|).

QPMC emphasizes that it can fully leverage the performance advantages of QAE without additional cost for two main reasons: (1) it directly constructs circuits from high-level model descriptions, and (2) the number of gates in the resulting circuit scales proportionally to the number of operations Op within the model, which is similar to the sampling time of SMC.

Discussion on Effectiveness: QPMC shows a square-root level speedup over SMC in terms of required samples, but it is practical mainly for large models (1<<|m|) and cases requiring high accuracy (ε<<1). (1) For small models, verification is sufficient with non-statistical approaches like sparse representation, so statistical methods like SMC or QPMC are not necessary. (2) For large models, statistical methods are essential due to the scalability limitations of non-statistical approaches. For example, handling a Leader Sync case study with a state space of 2¹⁰¹ or larger models is difficult with non-statistical methods. In contrast, both QPMC and SMC scale well. When processing a model with a state space of 2²⁰², the required resources (quantum bits and gates) only double, avoiding exponential resource growth. (3) While QPMC may be less efficient than SMC at low accuracies due to higher constant costs, it gains an advantage at high accuracies due to superior asymptotic complexity.

### Analysis of Optimization Effects

The number of gates and qubits in the circuits translated by QPMC are compared for case studies in terms of complexity and actual numbers.

Gate Complexity: Optimization maintains the number of gates at O(tlml). This is because the batch recycling strategy adds tᵢ−1 uncomputation circuits

$$( {C}_{u}^{- 1} )$$

in each i-th batch. Here, tᵢ denotes the number of transitions in the i-th batch. Since t=Σᵢtᵢ, the total number of uncomputation circuits is always less than t (Σᵢ(tᵢ−1)<t). Therefore, there is no change in gate complexity.

Qubit Space Complexity: Optimization reduces the number of qubits from O(t log₂ |S|+t|md|log₂ h) to O(√t log₂ |S|+t|md|log₂ h). Here, ‘md’ refers to the modules of m, and ‘h’ denotes the maximum number of probabilistic updates among all commands within model m. O(log₂ |S|) and O(|md| log₂ h) represent the number of qubits required for states and choices, respectively. Specifically, the total number of state qubits is reduced through the recycling strategy.

Case Study: The number of qubits and gates before and after optimization are compared in a PMC case study. For this, the number of qubits and gates in circuits generated by T and Tₒₚₜ are measured, considering gates X, R_{y}(θ), Ct^{\vec{b}}(X)

$${{Ct}^{\vec{b}} ( {R}_{y} ( θ ) )}_{( \vert \vec{b} \vert \leq 5 )}$$

according to Qiskit's level 2 gate optimization.

[Table 3] below shows the statistics of the benchmark models we used. We focus on four models with many modules commonly used in PMC tool evaluation: (1) Weather Factory: an example model calculating factory strike probabilities based on weather conditions, (2) Herman: a self-stabilizing algorithm for distributed systems, (3) Ising: a 1-dimensional Ising model for spin systems, (4) LeaderSync: a leader election protocol for distributed systems. The number of qubits and gates for these models are measured by increasing ‘t’ from 4 to 100 in increments of 4.

TABLE 3

| Model | \|\vec{md}\| | \|S\| | max\|\vec{λ}ₙᵤ\| | max\|\vec{λ}ᵤ\| |
|---|---|---|---|---|
| WeatherFactory | 25 | 2²⁶ | 2 | N/A |
| Herman | 25 | 2²⁵ | 2 | N/A |
| Ising | 20 | ≈2²⁴ | 2 | 20 |
| LeaderSync | 14 | ≈2¹⁰¹ | N/A | 4 |

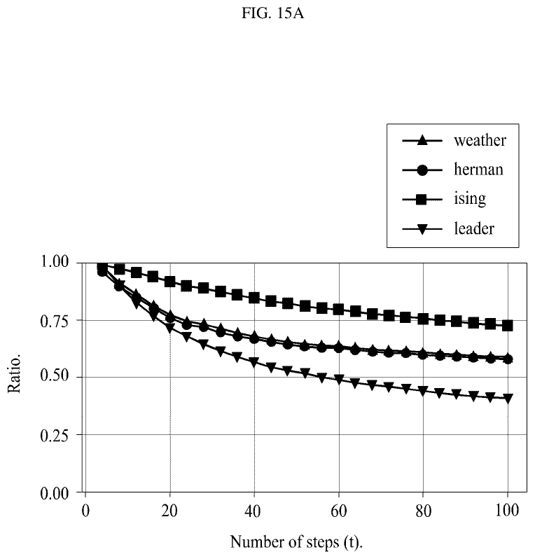

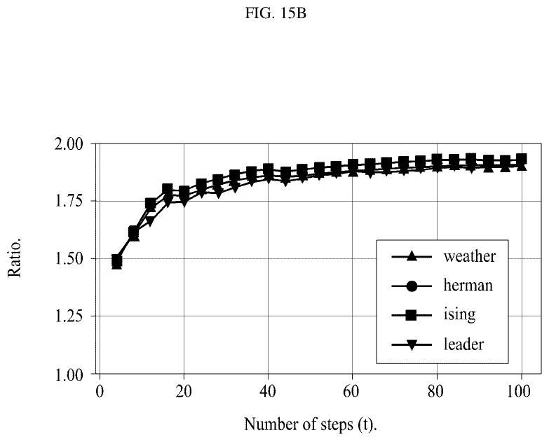

FIGS. 15A and 15B show the rate of change in the number of qubits and gates after optimization according to the present disclosure. In all models, as ‘t’ increases, the qubit reduction rate and gate increase rate become more pronounced, and optimization has a greater impact. For example, at t=100, the WeatherFactory, Herman, and Ising models show a 35% qubit reduction (from 5,887 to 3,469; from 5,551 to 3,226; from 8,515 to 6,190) and a 93% gate increase (from 285K to 543K; from 185K to 357K; from 1,153K to 2,229K), respectively. The Leader model shows a 59% qubit reduction (from 15,412 to 6,247) and a 91% gate increase (from 1,104K to 2,105K) due to its larger state space. This is because the reduction in the number of state qubits has a greater impact on the total qubit reduction. Although the qubit reduction rate varies depending on the state qubit ratio in the model, the gate increase rate is always less than 2.

Discussion on Effectiveness: While optimization significantly reduces the number of qubits, the translated circuits may not operate on current early-stage quantum computers. This is due to the limited qubit scale of current systems, typically comprising only hundreds of physical qubits, and inherent noise. However, a leading company, which is involved in quantum computing, aims to develop systems with thousands of logical qubits by 2030, making it possible for QPMC to address practical PMC problems in the near future. Along with these expectations, various quantum algorithms are gradually being introduced. For example, lithium-ion battery technology requires 10⁴ to 10⁵ logical qubits, and financial portfolio optimization may require more than 10⁷ logical qubits.

Now, a computing device (100) utilizing the techniques of the present disclosure described above and its operating method will be explained.

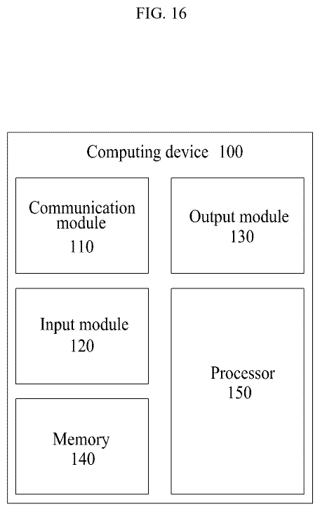

FIG. 16 is a diagram schematically illustrating a computing device (100) for Quantum Probabilistic Model Checking (QPMC) according to the present disclosure.

Referring to FIG. 16, the computing device (100) is for Quantum Probabilistic Model Checking and may include at least one of a communication module (110), an input module (120), an output module (130), a memory (140), or a processor (150). In some embodiments, at least one of the components of the computing device (e.g., communication module (110), input module (120), output module (130)) may be omitted. In some embodiments, at least one other component may be added to the computing device (100). In some embodiments, at least two of the components of the computing device (100) may be implemented as a single integrated circuit.

The communication module (110) can communicate with an external device from the computing device (100). The communication module (110) can establish a communication channel between the computing device (100) and an external device, and communicate with the external device through the communication channel. For example, the external device may include at least one of an electronic device, a base station, a satellite, or a server.

The communication module (110) may include at least one of a wired communication module or a wireless communication module. The wireless communication module may include at least one of a short-range communication module, a long-range communication module, or a GNSS (global navigation satellite system) communication module. The short-range communication module can communicate with an external device using a short-range communication method. The long-range communication module can communicate with an external device using a long-range communication method. Here, the long-range communication module can communicate with an external device via a network. For example, the network may include at least one of a cellular network, the Internet, or a computer network such as a LAN (local area network) or a WAN (wide area network). The GNSS communication module can receive GNSS information from a satellite. For example, the GNSS information may include GPS (Global Positioning System) information.

The input module (120) can input signals to be used by at least one component of the computing device (100). The input module (120) may be configured to detect signals directly input by a user or to generate signals by sensing changes in the surroundings. For example, the input module (120) may include at least one of a mouse, a keypad, a microphone, or a sensing module having at least one sensor. In some embodiments, the input module (120) may include at least one of a touch circuit configured to detect touch or a sensor circuit configured to measure the intensity of force generated by touch.

The output module (130) can output information to the outside of the computing device (100). The output module (130) may include at least one of a display module configured to visually output information or an audio output module capable of outputting information as an audio signal. For example, the audio output module may include at least one of a speaker or a receiver.

The memory (140) can store various data used by at least one component of the computing device (100). For example, the memory (140) may include at least one of volatile memory or non-volatile memory. The data may include at least one program and associated input data or output data. A program may be stored as software including at least one instruction in the memory (140), and may include at least one of an operating system, middleware, or an application.

The processor (150) can execute programs in the memory (140) to control at least one component of the computing device (100). Through this, the processor (150) can perform data processing or operations. At this time, the processor (150) can execute instructions stored in the memory (140). In the present disclosure, the processor (150) can convert the settings of Probabilistic Model Checking (PMC) into a quantum circuit that acts on an initial state for multiple qubits and a single qubit of Quantum Amplitude Estimation (QAE), and can estimate the probability that time-bounded properties are satisfied by utilizing this quantum amplitude estimation.

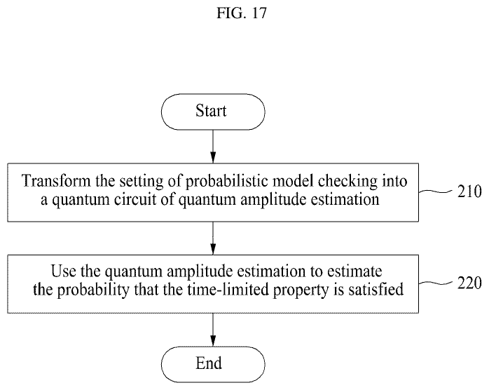

FIG. 17 is a diagram schematically illustrating an operating method of a computing device (100) for Quantum Probabilistic Model Checking (QPMC) according to the present disclosure.

Referring to FIG. 17, in step 210, the processor (150) can convert the settings of Probabilistic Model Checking into a quantum circuit that acts on an initial state for multiple qubits and a single qubit of Quantum Amplitude Estimation. Specifically, the processor (150) can preprocess the modules of the model, which are modeled through probabilistic model checking, to integrate them into a single system module. Then, the processor (150) can translate the system module into other quantum circuits that reflect state transitions. The other quantum circuits may be for generating the probability distribution of the next state by superposing parallel executions of activated transitions using qubits for the current state, guards, choices, and next state. Then, the processor (150) can configure sub-circuits of the quantum circuit using the other quantum circuits to translate the settings into a quantum circuit. The sub-circuits may include an initialization circuit for loading the probability distribution of the initial state of the settings, a transition circuit for repeatedly applying the other quantum circuits a predetermined number of times after loading the probability distribution of the initial state, and a result circuit for encoding the probability of reaching the target state into a single qubit after repeatedly applying the other quantum circuits a predetermined number of times.

Next, in step 220, the processor (150) can estimate the probability that time-bounded properties are satisfied by utilizing Quantum Amplitude Estimation. Specifically, the processor (150) can estimate the probability of measuring 11) in a single qubit by utilizing Quantum Amplitude Estimation.

In the present disclosure, the number of state qubits required for Quantum Probabilistic Model Checking can be minimized by repeatedly applying a batch recycling strategy. The batch recycling strategy may involve preserving the state qubits from the first state qubit up to the last state qubit, which are sequentially computed from the first state qubit, and then reusing the state qubits from the last state qubit back to the first state qubit during subsequent transitions.

The device described above may be implemented as hardware components, software components, and/or a combination of hardware and software components. For example, the devices and components described in the embodiments may be implemented using one or more general-purpose computers or special-purpose computers, such as a processor, a controller, an ALU (arithmetic logic unit), a digital signal processor, a microcomputer, an FPGA (field programmable gate array), a PLU (programmable logic unit), a microprocessor, or any other device capable of executing and responding to instructions. A processing device may execute an operating system (OS) and one or more software applications running on the operating system. Furthermore, the processing device may access, store, manipulate, process, and generate data in response to the execution of software. For convenience of understanding, although a single processing device has been described as being used, those skilled in the art will appreciate that a processing device may include multiple processing elements and/or multiple types of processing elements. For example, a processing device may include multiple processors, or a single processor and a single controller. Other processing configurations, such as parallel processors, are also possible.

Software may include a computer program, code, instructions, or a combination of one or more thereof, and may configure a processing device to operate as desired, or may independently or collectively instruct a processing device. Software and/or data may be embodied in any type of machine, component, physical device, computer storage medium, or device to be interpreted by a processing device or to provide instructions or data to the processing device. Software may be distributed across networked computer systems and stored or executed in a distributed manner. Software and data may be stored on one or more computer-readable recording media.

The methods according to various embodiments may be implemented in the form of program instructions executable by various computer means and recorded on a computer-readable medium. In this case, the medium may continuously store computer-executable programs, or temporarily store them for execution or download. Furthermore, the medium may be various recording or storage means in the form of a single or a combination of several hardware components, and is not limited to a medium directly connected to a particular computer system, but may exist distributed over a network. Examples of media include magnetic media such as hard disks, floppy disks, and magnetic tapes; optical recording media such as CD-ROMs and DVDs; magneto-optical media such as floptical disks; and ROM, RAM, flash memory, etc., configured to store program instructions. Additionally, other examples of media include recording or storage media managed by app stores or sites and servers that supply or distribute various other software applications.

The various embodiments described herein and the terminology used are not intended to limit the technology described in this document to specific implementations, and the embodiments should be understood to include various modifications, equivalents, and/or alternatives.

In the description of the drawings, similar reference numerals may be used for similar components. A singular expression may include a plural expression unless the context clearly indicates otherwise. In this document, expressions such as “A or B”, “at least one of A and/or B”, “A, B or C”, or “at least one of A, B and/or C” may include all possible combinations of the listed items. Expressions such as “first”, “second”, “primary”, or “secondary” may modify the corresponding components regardless of order or importance, and are used only to distinguish one component from another, not to limit the corresponding components. When a certain (e.g., first) component is referred to as being “(functionally or communicatively) connected” or “coupled” to another (e.g., second) component, the certain component may be directly connected to the other component, or connected through another component (e.g., a third component).

According to various embodiments, each of the described components (e.g., a module or a program) may include a single entity or multiple entities. According to various embodiments, one or more of the aforementioned components or steps may be omitted, or one or more other components or steps may be added. Alternatively or additionally, multiple components (e.g., modules or programs) may be integrated into a single component. In such a case, the integrated component may perform one or more functions of each of the multiple components in the same or similar manner as performed by the corresponding component among the multiple components before integration. According to various embodiments, a module, a program, or other steps performed by a component may be executed sequentially, in parallel, repeatedly, or heuristically, or one or more of the steps may be executed in a different order, omitted, or one or more other steps may be added.

What is claimed is:

1. A method of operating a computing device for Quantum Probabilistic Model Checking (QPMC), the method comprising:
converting a configuration of Probabilistic Model Checking (PMC) into a quantum circuit acting on an initial state for multiple qubits and a single qubit of Quantum Amplitude Estimation (QAE); and
estimating a probability that a time-bounded property is satisfied by utilizing the Quantum Amplitude Estimation.

2. The method of claim 1, wherein the step of converting the configuration of Probabilistic Model Checking into the quantum circuit of Quantum Amplitude Estimation comprises:
pre-processing modules of a model modeled through the Probabilistic Model Checking to integrate them into a single device module;
converting the device module into another quantum circuit reflecting state transitions; and
configuring sub-circuits of the quantum circuit using the other quantum circuit to convert the configuration into the quantum circuit.

3. The method of claim 2, wherein the sub-circuits comprise:
an initialization circuit for loading a probability distribution of an initial state of the configuration;
a transition circuit for repeatedly applying the other quantum circuit a pre-determined number of times after loading the probability distribution of the initial state; and
a result circuit for encoding a probability of reaching a target state into the single qubit after repeatedly applying the other quantum circuit the pre-determined number of times.

4. The method of claim 1, wherein the step of estimating the probability that the time-bounded property is satisfied by utilizing the Quantum Amplitude Estimation comprises:
estimating a probability of measuring ‘1’ from the single qubit by utilizing the Quantum Amplitude Estimation.

5. The method of claim 2, wherein the other quantum circuit is for generating a probability distribution of a next state by superposing parallel execution of activated transitions using qubits of a current state, a guard, a choice, and the next state.

6. The method of claim 1, wherein a number of state qubits required for the Quantum Probabilistic Model Checking is minimized by repeating a batch recycling strategy, and
the batch recycling strategy comprises preserving a last state qubit, sequentially calculated from a first state qubit, and reusing the qubits from the last state qubit back to the first state qubit during a subsequent transition.

7. A computing device for Quantum Probabilistic Model Checking, the computing device comprising:
a memory; and
a processor connected to the memory and configured to execute at least one instruction stored in the memory,
wherein the processor is configured to:
convert a configuration of Probabilistic Model Checking into a quantum circuit acting on an initial state for multiple qubits and a single qubit of Quantum Amplitude Estimation; and
estimate a probability that a time-bounded property is satisfied by utilizing the Quantum Amplitude Estimation.

8. The computing device of claim 7, wherein the processor is further configured to:
pre-process modules of a model modeled through the Probabilistic Model Checking to integrate them into a single device module;
convert the device module into another quantum circuit reflecting state transitions;
configure sub-circuits of the quantum circuit using the other quantum circuit to convert the configuration into the quantum circuit; and
estimate a probability of measuring ‘1’ from the single qubit by utilizing the Quantum Amplitude Estimation.

9. A non-transitory computer-readable recording medium storing a computer program for executing a method for Quantum Probabilistic Model Checking in a computing device, wherein the method for Quantum Probabilistic Model Checking comprises:
converting a configuration of Probabilistic Model Checking into a quantum circuit acting on an initial state for multiple qubits and a single qubit of Quantum Amplitude Estimation; and
estimating a probability that a time-bounded property is satisfied by utilizing the Quantum Amplitude Estimation.

10. The non-transitory computer-readable recording medium of claim 9, wherein:
the step of converting the configuration of Probabilistic Model Checking into the quantum circuit of Quantum Amplitude Estimation comprises:
pre-processing modules of a model modeled through the Probabilistic Model Checking to integrate them into a single device module;
converting the device module into another quantum circuit reflecting state transitions; and
configuring sub-circuits of the quantum circuit using the other quantum circuit to convert the configuration into the quantum circuit; and
the step of estimating the probability that the time-bounded property is satisfied by utilizing the Quantum Amplitude Estimation comprises:
estimating a probability of measuring ‘1’ from the single qubit by utilizing the Quantum Amplitude Estimation.
